(19) United States
(12) Patent Application Publication
(10) Pub. No.: US 2010/0151431 A1
(43) Pub. Date: Jun. 17, 2010

(54) VIRTUAL LEARNING

(75) Inventor: David E. Miller, Fairport, NY (US)

Correspondence Address: BROWN RUDNICK LLP, ONE FINANCIAL CENTER, BOSTON, MA, 02111, US

(73) Assignee: Knowledge Athletes, Inc., Fairport, NY (US)

(21) Appl. No.: 12/412,509

(22) Filed: Mar. 27, 2009

Related U.S. Application Data
(60) Provisional application No. 61/039,954, filed on Mar. 27, 2008.

(51) Int. Cl. G09B 3/00

(52) U.S. Cl. 434/350

(57) ABSTRACT

Collaborative computer-based learning allows a group of users to access, share, and contribute content. A computer-based system can be accessed by a community of users over a communications network. A data storage device can store data comprising items of teaching content and items of user content, such that the data is accessible by the community of users. A set of collaborative system tools can provide users with the ability to create an item of user content associated with items of teaching content or with other items of user content. An annotation mechanism can provide users with the ability to comment on items of teaching content or items of user content in the form of an annotation that is then stored in the data storage device. The annotation mechanism is configured to merge the annotation with the associated item of teacher or user content and generate merged content with the annotation overlaid on the associated item of teacher or user content.

### CROSS-REFERENCE TO RELATED CASE

This application claims priority to, and the benefit of Provisional U.S. Patent Application Ser. No. 61/039,954, filed Mar. 27, 2008, the entirety of which is incorporated herein by reference.

### TECHNICAL FIELD

The present invention generally relates to computer-assisted learning over an electronic network, and in particular to a collaborative learning system where a group of users are able to access, share, and contribute content.

### BACKGROUND INFORMATION

Traditionally, formal learning of any subject has been confined to physical classroom environments. In such environments, such as in a lecture or tutorial, there is one teacher assigned to instruct and guide a group of students. For instance, in a lecture environment, one teacher will be talking in front of a class of students, while the students listen and take notes. Thereafter, the students are left to do further reading on the subject and to prepare for assignments or tests. In classroom-based tutorials or seminars led by a teacher, there is some interaction between the teacher and students when the teacher questions the students on relevant topics to test their knowledge and discusses the subject in greater depth with them. In both cases, learning is highly teacher-centric, since the teacher is expected to lead the students through each lesson. There is no additional formal interaction between students after these tutorials, which may only occur once or twice a week for each subject. After these formal classroom lessons, students are generally left to study on their own. Any contact between individuals is made on an ad-hoc basis, and any advancement in knowledge resulting from such contact is often not shared with the rest of the class.

Teachers delivering knowledge in front of a class or lecture group has become the norm for efficiency and not pedagogical reasons. This is the inheritance of the industrial age, where instruction is standardized and mass-production is the goal. With the advent of the information age and the Internet, there has been a drive toward computer-assisted learning over networks, or what is commonly referred to as “e-learning”. The conventional e-learning system by and large supports and propagates the current practice of teaching and learning in two ways. One of these ways is the use of synchronous “virtual classrooms” to try to replicate the physical classroom through a virtual environment so that teachers and lecturers can conduct teaching online. This form of e-learning is no different in terms of being teacher-centric and at best is only as good as being physically present in the classroom or lecture hall.

Another type of e-learning system focuses on teaching and learning as a matter of delivering and acquiring content and knowledge. These e-learning systems are generally asynchronous in nature and are dedicated to delivering content and tracking the access of such content. They have been popular because they free up teaching time and make teaching even more efficient. They are often known as Course Management Systems or Learning Management Systems.

However, it is clear that such computer-assisted virtual environments are deficient in that they do little more than deliver teaching content through computers, while emphasizing traditional teacher-centric modes of learning. That is one reason why e-learning has not really lived up to its potential in enhancing learning. With regard to the teaching content, the instructor is the gatekeeper of knowledge, who feeds information to students. While there may be features like discussion forums that allow students to have discussions and shared folders for students to share files, these are teacher-directed and are not conceptually linked to the teaching content for reference purposes.

### SUMMARY OF THE INVENTION

A virtual learning system according to the invention is more learner-centric than known e-learning systems putting the emphasis on the communities of learners rather than concentrating too much emphasis on the teacher through undue reliance only on the input of the teacher during the learning process. Such a virtual learning system is useful in the current information age and beyond where higher-order thinking skills such as analysis, synthesis and evaluation, and life skills such as communication and interpersonal skills to collaborate effectively in teams are critical. All these can be better achieved by empowering the learners to construct their own knowledge in the context of virtual learning communities. It thus would be desirable to provide a system where students are allowed to initiate and generate content that is in turn linked back to teaching content to build upon the students' knowledge in a constructively collaborative way.

Systems and methods that turn social media and networking applications into powerful educational and analytical tools are described herein. The system includes a suite of products and technical elements that are delivered through online web-based classrooms, lessons, and assignments that guide students to use e-learning technology in a learning-centric and collaborative way. Students can engage with each other and teachers in online classrooms through the use of social networking technologies such as, for example, blogs, forums, profiles, instant messaging, as well as some more advanced software technologies that allow remote classroom peering and interaction. In addition, the system provides enhanced emoticons, called Grammaticons®, that enable teachers to easily track and report students' progress over time in learning performance and engagement with the subject matter. An emoticon is a textual portrayal of a writer's mood or facial expression. They are often used to alert a responder to the tenor or temper of a statement, and can change and improve interpretation of plain text. Examples of widely known emoticons are the smiley face :) and the frowny face :(. In web forums, instant messengers and online games, text emoticons are often automatically replaced with small corresponding images, which came to be called emoticons as well. Grammaticons® extend the functionality of current generation emoticons and provide a powerful and collaborative knowledge-building-system tool for extending the value of existing data, and facilitating the creation of new knowledge and collaboratively constructed knowledge. By creatively leveraging the technologies that are already very popular with students, the system and methods stand to deliver improved student interest in learning and contribute to enhanced personal development in critical thinking, lifelong literacy, creativity, and leadership. It also offers a structured and motivational framework for teachers to drive results utilizing innovative technologies.

The overall system provides a new and innovative methods of soliciting, collecting, organizing, annotating, assessing, aggregating, disaggregating, and securely linking content as it is being integrated and delivered by a web-enabled network on an internal or external website or HTML-based document or page. The content is in the form of data and information that is being developed, created, and recorded, for the purposes of individual and organizational knowledge creation, knowledge building, and organizational memory. These purposes are otherwise difficult to elicit and reveal, solicit and collect, and process toward adding value to individual lives and decision making, and toward adding value to organizational productivity.

The software system and its constituent components are useful within the fields of education, electronic office visits and their associated electronic medical records, and electronic point-of-need information presentation, among others that would benefit from developing information as it is newly elicited and revealed, solicited and created, organized, annotated, individually and collaboratively assessed, aggregated and disaggregated, and securely linked to existing, new, and newly developing data and information based on one or more data-driven rubrics to provide additional insight to the person interpreting the information.

In one embodiment, this software system provides elements that comprise an online educational and classroom software system that provides web-based and web-enabled classrooms that include many of the elements described herein and which allows schools to provide teachers and students with a contemporary software platform that bridges traditional classroom practices with Internet technologies.

In one aspect, the invention relates to a computer-readable medium storing computer-executable program instructions that, when executed, cause one or more computers to enable a user in a community of users to generate one or more items of user content. Each item of user content is associated with one or more items of teaching content or another item of user content. It also enables the user to generate an annotation associated with at least one item of teaching content or user content and displays the annotation overlaid on the associated item of teacher or user content. In alternative embodiments, the computer-executable program instructions also cause the one or more computers to identify patterns in the items of teaching content and the items of user content indicative of similar topics. The items related to similar topics can be linked to each other or linked to an external source over a communications network such as, for example, the World Wide Web.

In another aspect, the invention relates to an apparatus for providing a collaborative learning environment accessible by a community of users over a communications network that includes a memory storing a program and a processor in communication with the memory for executing the program and thereby causing the apparatus to enable a user in a community of users to generate one or more items of user content associated with one or more items of teaching content or another item of user content. The apparatus also enables the user to generate an annotation associated with at least one of the item of teaching content or user content and displays the annotation overlaid on the associated item of teacher or user content. In alternative embodiments, the program also causes the apparatus to identify patterns in the items of teaching content and the items of user content indicative of similar topics and links the similar topics to each other or to an external source over a communications network such as, for example, the World Wide Web.

In yet another aspect, the invention relates to a system for providing a collaborative learning environment accessible by a community of users over a communications network that includes means for storing data comprising one or more items of teaching content and one or more items of user content. The items of teaching content include content previously stored in the data storing means, and the items of user content include content generated by the community of users. The system also includes means for generating one or more items of user content associated with one or more items of teaching content or another item of user content. The system also includes means for generating an annotation associated with at least one item of teaching content or at least one item of user content and means for displaying the annotation overlaid on the associated item of teacher or user content. In alternative embodiments, the system includes means for identifying patterns in the items of teaching content and the items of user content indicative of similar topics and means for providing a link to items of teaching content or items of user content identified as being similar or a link to an external source over a communications network. In further alternative embodiments, the system includes means for managing content configured to provide users with personalized disk space in the data storing means. The means for managing content can include a media library for storing online media files. Additionally, the system can includes means for embedding HyperText Markup Language (HTML) into items of teaching content and means for linking a plurality of online classrooms over a communication network. The plurality of online classrooms include one or more teachers and one or more students linked over a communications network that allows students and teachers in one online classroom to share items of teaching content and items of user content with students and teachers in other online classrooms.

In a further aspect, the invention relates to a method for providing a collaborative learning environment to an online community of users that includes providing a data storage device for storing data comprising a plurality of items of teaching content, generating one or more items of user content associated with the items of teaching content or another item of user content, generating an annotation associated with at least one item of teaching content or at least one item of user content, and displaying the annotation overlaid on the associated item of teacher or user content. The method can also include identifying patterns in the items of teaching content and the items of user content indicative of similar topics linking the similar topics to each other or to an external source such as, for example a universal resource locator (URL) link to one or more websites.

In yet a further aspect, the invention relates to a computerized collaborative learning system that includes a data storage device for storing data comprising one or more items of teaching content and one or more items of user content. The items of teaching content include content previously stored in the data storage device and the items of user content include content generated by a community of users. The system also includes a set of collaborative system tools operable to provide a user in the community of users the ability to generate an item of user content associated with items of teaching content or other items of user content. The system also includes an annotation mechanism operable to enable users in the community of users to generate an annotation associated with items of teaching content or items of user content for storage in the data storage device. The annotation mechanism is configured to merge the annotation with the associated item of teacher or user content and generate merged content with the annotation overlaid on the associated item of teacher or user content. In alternative embodiments, the system includes a display device for displaying the merged content with the annotation overlaid on the associated item of teacher or user content and/or a pattern identification mechanism operable to identify patterns in items of teaching content and items of user content indicative of similar topics.

In another embodiment, this software system provides elements that comprise a digital triage software system that provides a web-based front-end and information collection and assessment platform for patients, caregivers, and medical service providers to more effectively and efficiently diagnose and treat maladies and develop a more robust, complete, and secure patient electronic office visit (and associated electronic medical record) by collecting and assessing patient-provided information that is not typically collected prior to a patient visit to a medical treatment facility.

In yet another embodiment, this software system provides elements that comprise enhanced data and information reporting and security for point-of-need information presentation. For example, if an insurance provider or a public health agency required aggregated reporting of disaggregated medical information while maintaining the anonymity of patients and/or medical service providers, the security elements of this software, in combination with the data collection functions as linked to electronic office visits and medical records software, the software elements described herein provide this functionality.

### BRIEF DESCRIPTION OF THE DRAWINGS

A fuller understanding of the aspects, objects, features, and advantages of certain embodiments according to the invention will be obtained and understood from the following description when read together with the accompanying drawings, which primarily illustrate the principles of the invention and embodiments thereof. The drawings are not necessarily to scale and like reference characters denote corresponding or related parts throughout the several views. The drawings and the disclosed embodiments of the invention are exemplary only and not limiting on the invention.

FIG. 1 is a block diagram illustrating a networked computer system for collaborative learning in accordance with one exemplary embodiment of the present invention.

FIG. 2 is a block diagram showing a hardware configuration of a computer machine.

FIGS. 3A, 3B, and 3C are exemplary screenshots illustrating the system management interface from which users can access and use the collaborative learning computer system.

FIG. 4 is a schematic illustration of assignment questions linked to one or more media files.

FIG. 5 is a block diagram illustrating an adjunct lesson creation element that provides a method for turning multiple sources of content into structured educative events that teachers can use for their lessons.

FIG. 6 is an exemplary screenshot illustrating the assignment phase element that provides teaches with the ability to categorize the assignments in several ways in order to promote individual or collaborative work across the classroom or in limited sized groups within the classroom.

FIG. 7 is a schematic illustration of the scheduled social networking feature of the assignment phase element of FIG. 6 that allows teachers to schedule the time at which posted data is revealed to other users.

FIG. 8 is a schematic illustration of the create your response element that allows students to post content in response to the teacher's lessons or assignments or in response to other student postings.

FIG. 9 is a schematic illustration of the expand your response element that allows students and teachers to post content in response to other student or teacher postings.

FIGS. 10A and 10B are schematic illustrations of the user profile and portal page.

FIG. 11A is a block diagram illustrating the assessment element that allows teachers to easily track and report students' progress over time.

FIGS. 11B-11G are exemplary screenshot illustrating the annotation of text and assignment of a Grammaticon®.

FIG. 11H-11I are exemplary screenshot illustrating of the use of Grammaticon® technology to provide quantitative scoring/assessment by assigning Likert-scale ratings to a Grammaticon® icon.

FIG. 11J is an exemplary screenshot illustrating of the use of Grammaticon® technology to add comments to each Grammaticon® that is assigned.

FIGS. 12A and 12B are schematic illustrations of a peering arrangement established between two classrooms.

FIG. 13 is a schematic illustration of the notification element and the What's Due reporting feature.

FIG. 14 is a schematic diagram illustrating the use of granular Unique Identifiers for increased functionality and user security.

FIG. 15 is a schematic diagram illustrating of the use of Grammaticon® technology for advertising.

### DESCRIPTION

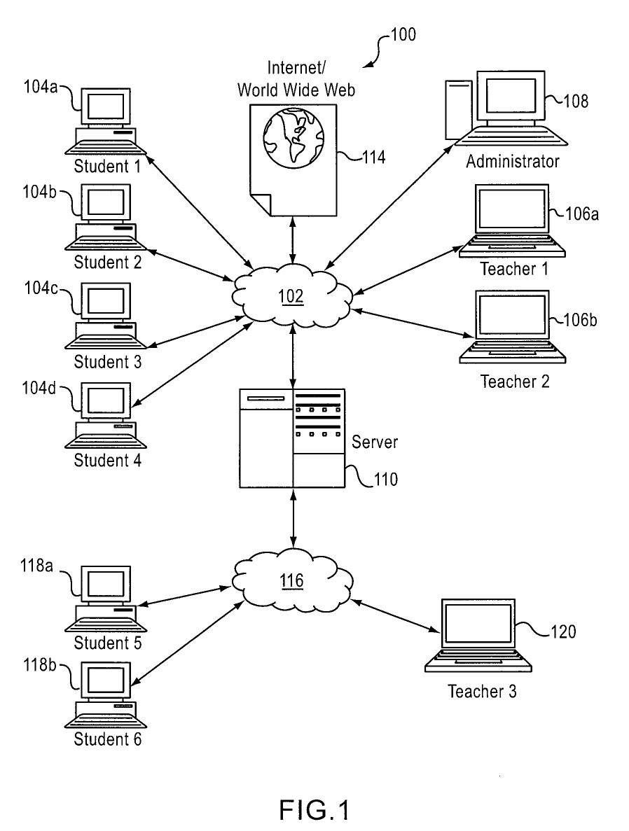

FIG. 1 illustrates a networked computer system 100 for collaborative learning that provides teachers and students a computer-based platform that bridges traditional classroom practices with Internet technologies in accordance with an embodiment of the invention. In the illustrated embodiment, the computer system 100 includes web-based educational and classroom software that is accessible by one or more communities of users through an electronic communications network 102, which is typically a Local Area Network or Wide Area Network such as the Internet. One or more of any other type of network suitable for communications such as, for example, a Personal Area Network, a Campus Area Network, and/or a Metropolitan Area Network are possible alternatives or additions to the communications network 102.

A group of users, which may comprise one or more students 104a, 104b, 104c, 104d, teachers 106a, 106b, and/or administrators 108 can access a server computer 110 through the network 102. The users can access the server computer 110 with a desktop computer, a laptop computer, or a portable computing device such as, for example, a cellular phone or Blackberry. In this way, the students 104 and teachers 106 can access the server computer 110 for teaching, learning, and collaboration even though they are physically not at the same location. Students 104 can be defined broadly as persons who access the system primarily to gain knowledge or understanding of a skill. Teachers 106 can be defined broadly as persons whose primary role is to impart knowledge to or guide the students. Administrations 108 can be defined broadly as persons whose primary responsibility is to oversee the overall educational process such as, for example, principals, superintendents, school boards, and departments of education. It is envisioned, however, that in the collaborative learning system 100 according to the present invention, all users take on roles as both learner and educator.

The server computer 110 includes various modules such as educational and classroom application software, a storage device for storing and maintaining a database and archived information, educational content for preparation of lessons and assignments, student biographical information for online classroom registration, and assessment components and data. The server computer 110 may comprise just one computer or a plurality of computers connected to the network 102 that can support use by a plurality of users simultaneously. Furthermore, a link to the Internet 114 provides access to the World Wide Web and its vast collection of educational content.

The computer system 100 can also include various modules to provide a secure link between one electronic communications network 102 with one or more additional networks such as, for example, a second educational institution network 116. The second network 116 may include a distinct group of students 118a, 118b and teacher(s) 120. The various modules linking the two separate networks 102, 116 provides a communications mechanism that allows students 104 and teachers 106 in one virtual or online classroom to share content with students 118 and teachers 120 in peer classrooms.

Certain disclosed embodiments relate to and/or include computer storage. The storage can be in the form of one or more computer-readable mediums having data and/or executable instructions (also called computer programs, code, or software) stored thereon or therein. The software is for performing various computer-implemented processing operations such as any or all of the various operations, functions, and capabilities described herein. The term “computer-readable medium” is used herein to include any medium capable of storing data and/or storing or encoding a sequence of computer-executable instructions or code for performing the processing operations described herein. The media and code can be those specially designed and constructed for the purposes of the invention, or can be of the kind well known and available to those having ordinary skill in the computer and/or software arts. Examples of computer-readable media include computer-readable storage media such as: magnetic media such as fixed disks, floppy disks, and magnetic tape; optical media such as Compact Disc-Read Only Memories (“CD-ROMs”) and holographic devices; magneto-optical media such as floptical disks; memory sticks “flash drives” and hardware devices that are specially configured to store and execute program code, such as Application-Specific Integrated Circuits (“ASICs”), Programmable Logic Devices (“PLDs”), Read Only Memory (“ROM”) devices, and Random Access Memory (“RAM”) devices. Examples of computer-executable program instructions or code include machine code, such as produced by a compiler, and files containing higher level code that are executed by a computer using an interpreter. For example, an embodiment of the invention may be implemented using Java, C++, or other programming language and development tools. Additional examples of instructions or code include encrypted code and compressed code. Other embodiments of the invention can be implemented in whole or in part with hardwired circuitry in place of, or in combination with, program instructions/code.

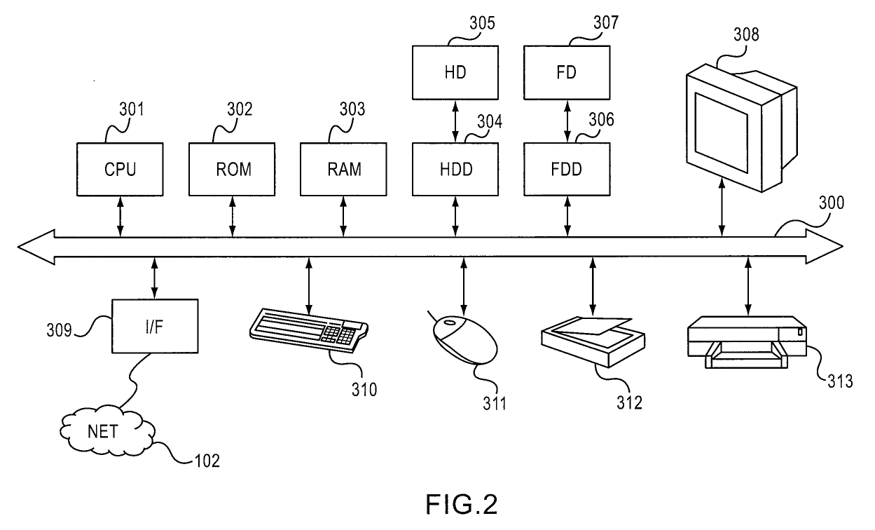

FIG. 2 is a block diagram showing a hardware configuration of a computer machine for use in the system 100 shown in FIG. 1. As described above, students 104, 118, teachers 106, 120, and/or administrators 108 can use a computer to access the server computer 110 over a communications network 102. Any of the computers described herein, including the server computer 110, can be a desktop computer, a laptop computer, a tablet PC, a cellular telephone, a Blackberry, or any other type of computing device that can access a communications network 102. In FIG. 2, the computer machine includes a CPU 301, a ROM 302, a RAM 303, an HDD (hard disk drive) 304, an HD (hard disk) 305, an FDD (flexible disk drive) 306, an FD (flexible disk) 307, which is an example of a removable recording medium, a display 308, an I/F (interface) 309, a keyboard 310, a mouse 311, a scanner 312 and a printer 313. These components are respectively connected via a bus 300 and are used to execute computer programs described herein

Here, the CPU 301 controls the entire computer machine. The ROM 302 stores a program such as a boot program. The RAM 303 is used as a work area for the CPU 301. The HDD 304 controls the reading/writing of data from/to the HD 305 under the control of the CPU 301. The HD 305 stores the data written under the control of the HDD 304. The FDD 306 controls the reading/writing of data from/to the FD 307 under the control of the FDD 306. The FD 307 stores the data written under the control of the FDD 306 or causes the computer machine to read the data stored in the FD 307.

The removable recording medium may be a CD-ROM (CD-R or CD-RW), an MO, a DVD (Digital Versatile Disk), a memory card or the like instead of the FD 307. The display 308 displays data such as a document, an image and functional information, including a cursor, an icon and/or a toolbox, for example. The display 308 may be a CRT, a TFT liquid crystal display, or a plasma display, for example.

The I/F 309 is connected to the network 102 such as the Internet via a communication line and is connected to other machines over the network 102. The I/F 309 takes charge of an internal interface with the network 102 and controls the input/output of data from/to an external machine. A modem or a LAN adapter, for example, may be adopted as the I/F 309.

The keyboard 310 includes keys for inputting letters, numbers and commands and is used to input data. The keyboard 310 may be a touch-panel input pad or a numerical keypad. The mouse 311 is used to move a cursor to select a range to move or change the size of a window. A trackball or joystick, for example, may be used as a pointing device if it has the same functions.

The scanner 312 optically scans an image and captures the image data into the computer machine. Notably, the scanner 312 may have an OCR function. The printer 313 prints image data and/or text data. A laser printer or an ink jet printer, for example, may be adopted as the printer 313.

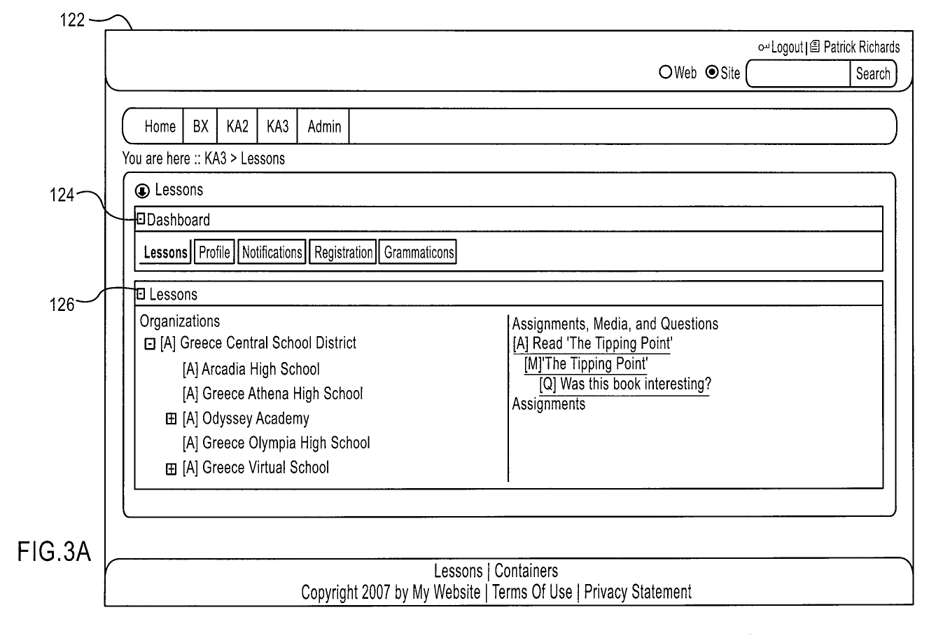

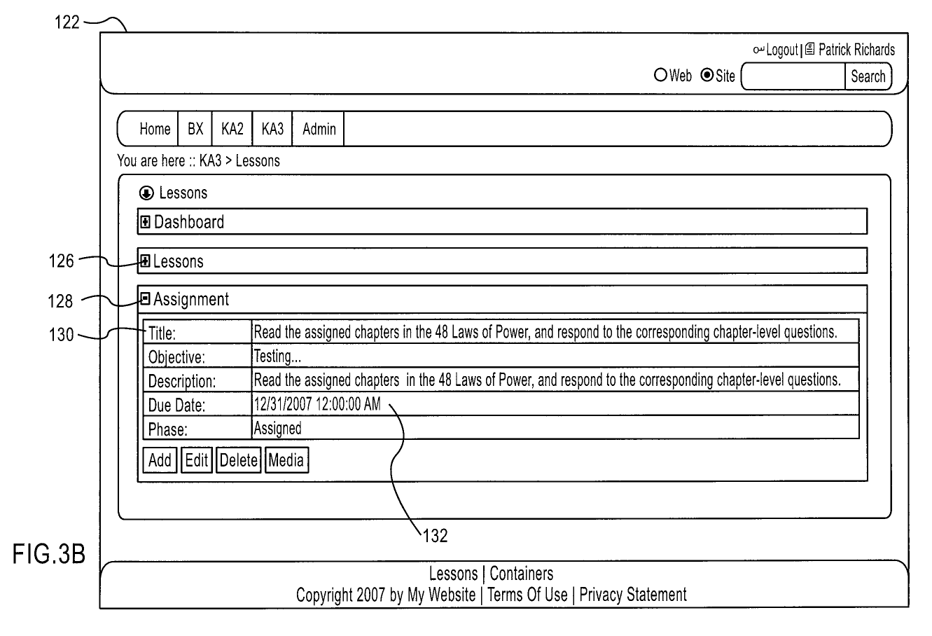

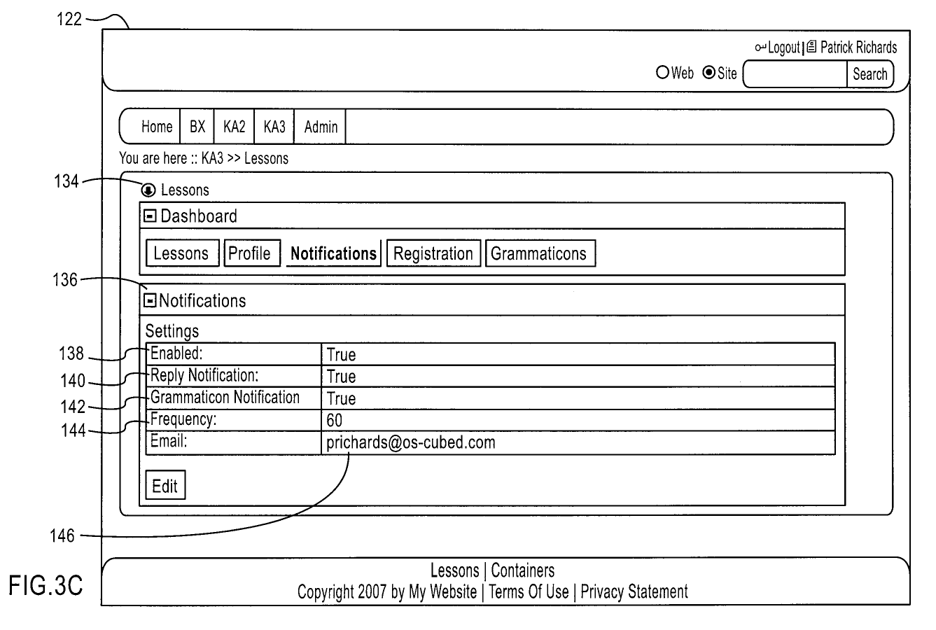

Referring now to FIGS. 3A-3C, the server computer 110 stores a set of computer programs that implement the online classroom operations described herein. In the illustrated embodiment, the classroom application software includes a dashboard element 122. The dashboard element 122 is a system management interface that allows teachers to create and manage online classrooms. For example, a teacher can use the dashboard element 122 to generate and assign student registrations (e.g., logins and passwords) for online classroom registration. After the online classroom is created, the teacher can use the dashboard element 122 to set up lessons and student assignments, link lessons to internal or external media sources, post notes, questions, and assignment objectives, and monitor the status of individual assignments. The dashboard element 122 also provides the interface for teachers to publish content for use by other teachers, establish secure connections with other peer classrooms, choose and create Grammaticon® assessment components for their online classrooms, and set up teacher/creator-specified access control parameters to manage classrooms and assignments.

FIG. 3A illustrates the dashboard element 122 with the lessons button 124 selected to expand the lessons dialog box 126. As shown, the dashboard 122 includes a framework for teachers to view assignments that are being used in one or more schools or classes. Often times teachers teach the same or different lessons to one or more groups of students and sometimes at different schools. This framework shown if FIG. 3A allows the teacher to manage their lessons 124 and to view and specify which lessons are being used in particular classes and/or school organizations.

As part of a lesson, a teacher can set up an assignment for the students to complete on their own. For example, FIG. 3B illustrates the dashboard element 122 with the assignment dialog box 128 expanded. As shown, a teacher has created an assignment 130 titled “Read the assigned chapters in the 48 Laws of Power, and respond to the corresponding chapter-level questions.” The assignment 130 can have one or more associated or linked media such as, for example, books, chapters from a book, online video and/or audio files, podcasts, vodcasts, and sites or other online or paper-based references. Since the system 100 is web-based, the teacher has the entire World Wide Web at his or her disposal as a source for educational content. As part of the assignment, the teacher can also develop one or more questions that are linked to the media. This assignment feature 128 also includes a framework that allows the teacher to specify dates and times for students to work on assignments including, for example, a start date (not shown), a due date 132, an open date (not shown) for assignments that are created ahead of time, as well as times for private assignments to open to the entire classroom.

The dashboard element 122 also includes notification parameters 134 for notifying teachers and/or students when there is activity in an assignment while the assignment is in an assigned or open phase. FIG. 3C illustrates the dashboard 122 with the notifications dialog box 136 expanded to show that the notifications settings are enabled 138, the teacher and student are notified when a someone replies 140, the teacher and student are notified when someone creates a Grammaticon® 142, the frequency 144 of notifications, and the method of notification 146, in this case an email will be sent to prichards@os-cubed.com.

As described above, the creator of a lesson or assignment can link one or more media sources to a set of questions that the lesson creator is developing. Within this element, the lesson/assignment creator selects the media that he or she wishes to use, specifies the link that identifies the media for use within the lesson such as, for example, a universal resource locator (URL), an embedded html tag, RSS feed, or printed text (online or in a physical book), and then creates and posts questions for students to answer while studying the linked media. The computer system 100 described herein also provides a mechanism for a lesson/assignment creator to embed the links and embedded HTML tags so that students can easily access specified media that is hosted remotely by one or more content providers from the online classroom. The embedded media allows students to respond to assignment questions within the online classroom, real-time with 24/7 access. Students can securely access posted media links and attached questions wherever they have access to the Internet and browser software.

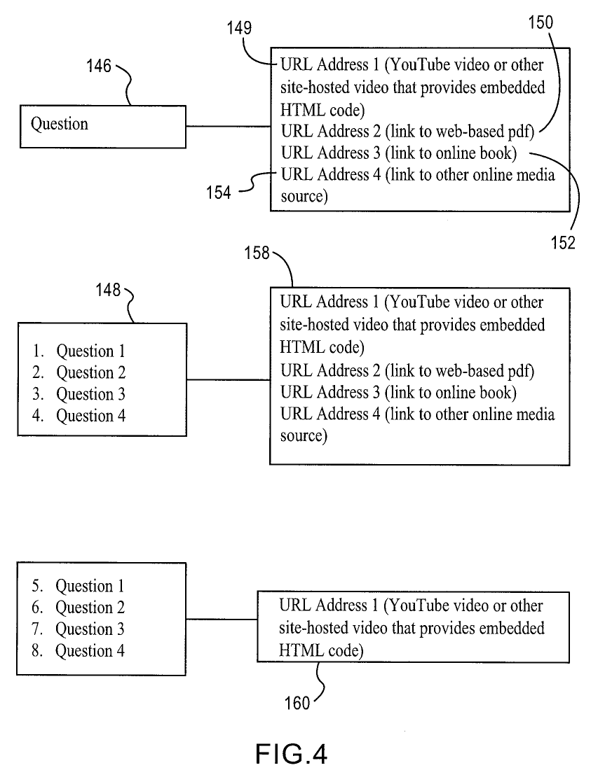

For example, as illustrated in FIG. 4, a question 146, or series of questions 148 in an assignment can be linked to a video or audio clip 149 for which the lesson creator has specified an embedded link or URL link for the student to access, watch or listen to the clip 149, and then answer the question 146 or questions 148 in the assignment. As an alternative example, the lesson creator can post his or her lesson notes 150 as a web-based PDF file or provide a link to class notes on another hosted site that students can access within the assignment before responding the questions 146, 148. Other examples include access to an online book 152 through the embedded media link or other online media sources 154 than can be read or viewed prior to answering the assignment questions 146, 148. In alternative embodiments, a single question 146 can be linked to a single media source 160, multiple questions 148 can be linked to multiple media sources 158, or any combination thereof.

The computer system 100 can include a content management system that provides users with a central repository for storing media files, URL links, or other course materials for reuse in multiple classes or lessons. For example, for teachers, the content management system can provide a media library for storing online media for reuse in multiple courses or lessons. It can be used by teachers (or other lesson creators) to easily assign different media content for lessons, specific portions or media content for different lessons, or store media content or notes for future use. The content management system can provide simplified access to the media content via the dashboard interface 122. It can also provide flexible access control allowing teachers to easily share course materials with other teachers or lesson creators.

Students can also use the content management system as Internet based personal disk space, accessible anytime and anywhere they have access to the Internet and browser software. For example, the content management system can allow students to create personalized online storage directories (e.g., “My Research” or “History Lessons”) to securely store materials online including homework, assignments, and research. The content management system can be used to create and display portfolios for storing and sharing of material and selected personal information to other users for completing assignments, for group projects, for student organizations, for submitting workflows for assignments and homework, or simply to save research for future use. It can also be used for storing and sharing of materials. In addition, the content management system can also provide a secure encrypted method of sharing content.

The content management system can also be used by other users such as, for example, third party lesson creators, librarians, or school administrators, for storing online media, electronic texts, and research for use by a group of users (e.g., all math teachers, all 4^{th} grade teachers, or an entire school district). For example, if a teacher makes a request for online media from the school librarian on a specific subject (e.g., the Battle of Gettysburg), the librarian can post the copyright cleared material to a portfolio in the content management system. The librarian can then give access to that portfolio to any number of users such as, for example, to individual teachers, groups of teachers by discipline, groups of teachers by department, or groups of teachers or students associated with a particular course or course category. The access to the portfolio can be limited to “read” access that only allows the user to view or use the content posted in the portfolio, or alternatively, the users can be given “read/write” access that allows users to post additional content as it is discovered or becomes available online to supplement the original posting by the librarian.

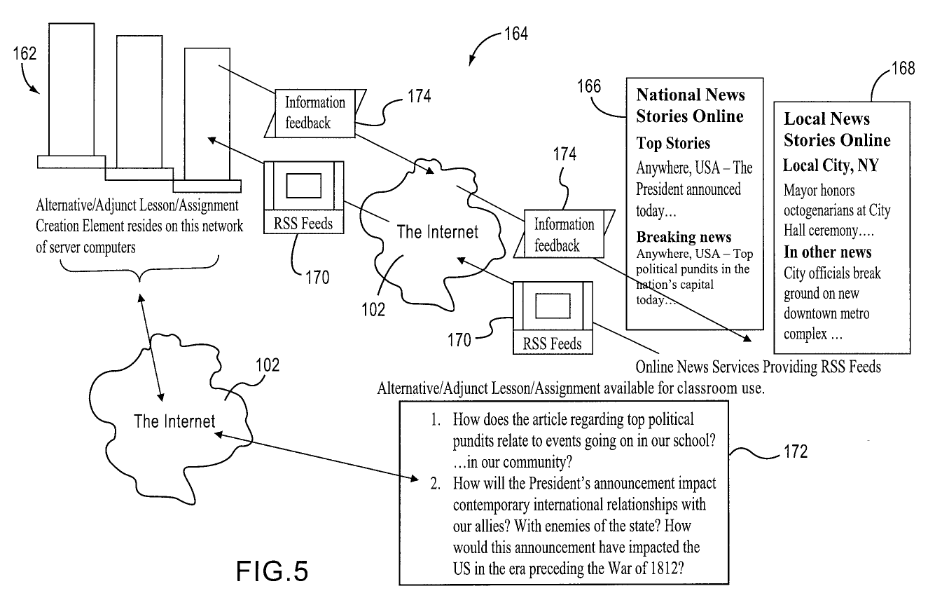

Referring now to FIG. 5, the system 100 can include an adjunct lesson creation element 162 that provides a method 164 for turning multiple sources of content into structured educative events that teachers can use for their lessons. For example, online news services provided by media reporting organizations such as The New York Times, The Rochester Democrat & Chronicle, or CNN could provide RSS feeds of the top daily or weekly stories to hosted classrooms. A series of questions could then be created by the news service or another question-creating entity, and those questions could be linked to the news-event RSS feeds so that teachers can select which questions they want to use for their lessons. In an alternative embodiment, business organizations could provide RSS feeds of their company news, events, and other information to participating classrooms, and questions could be generated to create a collaborative communication structure between the business organization and one or more classrooms that would comment on the information provided by the business organization.

This adjunct lesson creation element provides schools with contemporaneous online classroom content relevant to certain subject areas and provides the news source or business organization (with permission of the school, parents, and students) with feedback on their provided stories/news articles so that the news/business source provider could dig deeper and collaborate with classrooms based on the volume of feedback provided. This could also be linked to a Unique Identifier (UID) component built into the security function so that student identities would not be revealed and yet the value to the news/business source information provider could be enhanced through collaboration with students and other permitted outside entities.

For example, as shown in FIG. 5, a National 166 or Local 168 news service could provide their reported news content through RSS feeds 170 over a communications network 102 to a teacher or other curriculum development individual or organization. The teacher or curriculum developer can create questions 172 about the news content, post this as an online assignment in the online classroom, and student/class participants respond to the questions online. In an alternative embodiment, the set of questions 172 are created by the news service and linked to the news content included in the RSS feed 170. Individual responses 174, disaggregated from the student identity for security reasons, could then be provided back to the news service over the communications network 12.

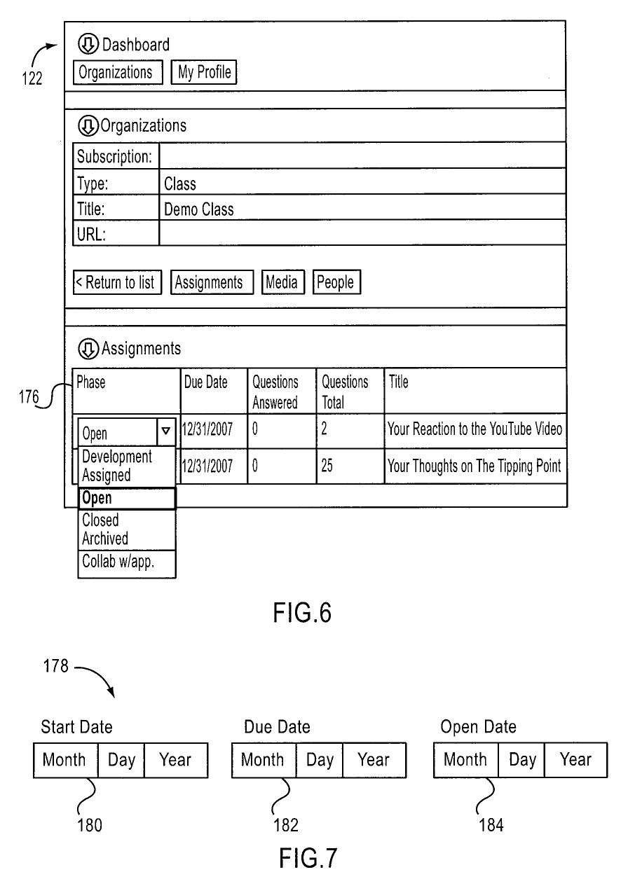

Referring now to FIG. 6, while a teacher is creating lessons and assignments, an assignment phase element 176 provides teaches with the ability to categorize the assignments in several ways in order to promote individual or collaborative work across the classroom or in limited sized groups within the classroom. The phases from which a teacher can choose include development, assigned, open, closed, archived, and collaborate with approval. The development phase categorization allows the teacher to create a lesson with assignments and the lesson and assignments cannot be seen by anyone except for the teacher. When the teacher wants students to view and do the assignment, the teacher can change the categorization to “assigned” which allows one-to-one visibility and exchange of ideas, thoughts, comments, and assessment between the teacher and an individual student. Multiple students can be in the classroom working on the assignment, but the interactive and asynchronous exchange between teacher and student is visible only to the teacher and the individual student. In this phase, no students in the classroom can see the posted work of any other student in the class or the comments and assessments posted by the teacher for other students.

If the teacher has set a specific assignment due data and time, the system 100 can automatically convert the assignment from the assigned phase to the closed phase. In the closed phase, students are not allowed to post responses or make comments on the assignment. The teacher can also manually change the assignment status to closed if a due date was not originally specified or in the event that they feel the need to prematurely end the assignment. When an assignment is categorized as closed, both the teacher and the students can still view all of the online responses, comments, and assessments, but students can no longer make changes or additions to their responses (i.e., teachers or administrators can still have the ability to post responses, comments, and assessments and the students can view the teacher's comments).

After the due date of the assignment has been reached and the teacher has completed their commenting/assessment of the students' work, the assignment can be changed to the archive phase. In the archive phase, students are not allowed to post responses or make comments on the assignment, and the students are no longer able to view the assignment or responses. All of the classroom work for the archived assignment is stored, but in the archived phase, the teacher (or another user with administrative rights) is the only one that can view the assignment and responses. In the archived phase, the teacher can also be allowed to post comments for assessment purposes that can only be viewed by the teacher and administrators. After the assignment has been archived, a user with administrative rights such as, for example, the teacher, can re-enable viewing by changing the phase of the assignment from archived to some other phase which is viewable by students, such as the assigned, open, or closed phase.

The teacher also has the option of posting an assignment with a “open” categorization which allows many-to-one and many-to-many visibility of posted ideas, thoughts, comments, and assessment notes between teacher and students and among all users in the online classroom. Multiple students can be in the classroom, and the asynchronous exchange between teacher and student or between student and student is visible by all members of the classroom. During this phase, each student in the class can see the posted work and comments on posted work of any other student in the online classroom. Users do have the option to override the open phase for individual posts or comments by marking the post private, in which case the exchange between teacher and student is visible only to the teacher and the individual.

Another example of an assignment phase that can be used to provide teachers with further control of the student collaboration is collaborate with approval. During this phase, multiple students can be in the classroom, and the asynchronous exchange between student and student is only visible by other students of the classroom after the post has been approved by the teacher. For example, if a student posts a reply that is not appropriate or offensive, the teacher can screen that content before any of the other students see the reply. Furthermore, instead of simply deleting the reply, the teacher has the option of posting their own response to the reply which gives the teacher an opportunity to explain to the student why he/she feels it is not appropriate for the rest of the class to see. This can be as simple as a misspelled word or a misunderstanding of the assignment to prevent embarrassment of the student. This also gives the student an opportunity to correct his/her mistakes so the post can be approved by the teacher. Other assignment phases are also possible that allow specific groups of users or subsets of groups of users to view and comment on assignments that are being developed or assignments that have already been used with or without success in an online classroom. For example, assignment phases could be established that allow teachers to collaborate on the creation of new assignments or for teachers, administrators, and educational experts to evaluate and comment on new or existing assignments.

Referring now also to FIG. 7, another aspect of the assignment phase element 176 includes scheduled social networking 178. The scheduled social networking 178 allows teachers to schedule the time at which posted data is revealed to others. For example, after the assignment due date has been reached, posted data (e.g., student and teacher responses) becomes public for others within the specific (or peered/linked) classroom to see. Teachers can then create additional assignments that require students to reply to other student posts. Most social networking tends to be instantaneous such that an online post is instantly viewable by all others who have access to the social networking site or page. However, with the scheduled social networking 178 feature, social networking can be scheduled based on the needs of the teacher or the facilitating organization. This also delineates an approach to social networking and online classroom data presentation into separate modes that includes a private content posting sequence with commenting between student and teacher, as well as a scheduling capability that can convert the private content posting sequence into a collaborative work environment. After the classroom converts to the collaborative work environment, the user's identity who posted content during the private sequence can either remain anonymous, or shared with the rest of the group.

As shown in FIG. 7, the scheduled social networking 178 process starts with an assignment that has been converted to the assigned status by the teacher on a particular start date 180. After the start date 180 all of the students can be in the classroom working on the assignment with one-to-one visibility and exchange of ideas, thoughts, comments, and assessment between the teacher and each individual student. During this phase, no students in the classroom can see the posted work of any other student in the class or the comments and assessments posted by the teacher for other students. At some time after the assignment due date 182, the assignment converts to a closed or archived status to prevent further participation from the student. The assignment can also be converted to an open assignment at a predetermined open date 184 to allow collaborative student-to-student interaction or more fully open in terms of social networking. The open date 184 can be set when the assignment is initially created or assigned. Furthermore, the open date 184 can be before or after the due date 182.

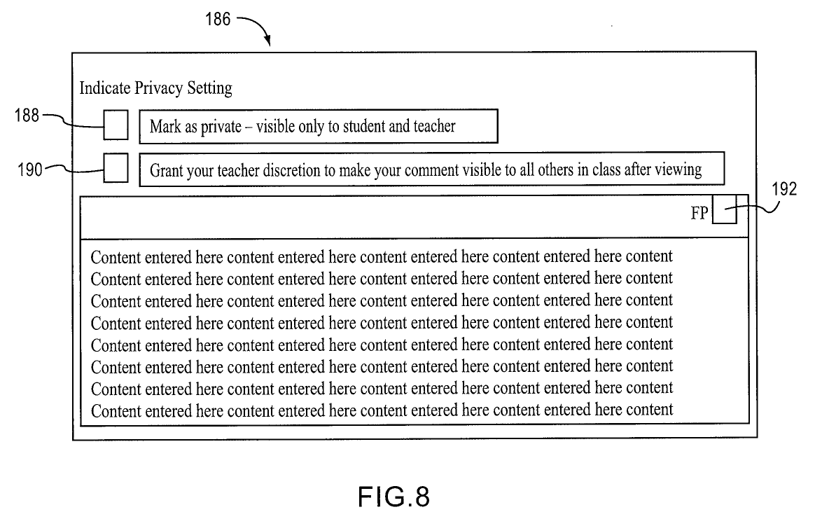

Referring now to FIG. 8, a create your response element 186 allows students to post content in response to the teacher's lessons or assignments or in response to other students postings. The create your response element includes a mark private 188 feature that allows individual student to publish his/her content for viewing by the student and the teacher only by checking the box labeled to mark as private 188. This feature is available to the students during all assignment phases (except within the development phase where students cannot see the assignments at all) including assigned, open, closed, archived, and collaborate with approval.

The mark private 188 feature being available to students at all times provides additional privacy beyond the typical privacy between teacher and student within the assigned category of assignment type. For example, if a student has something to communicate in a lesson forum, and if the lesson forum is an “open” lesson, a student who wants to share something privately with only the teacher can check the “Mark as private—visible only to student and teacher” box, and the student's post is not available for other students to see. Teachers can then override this check box, but not without the permission of the student. Teachers can also check the mark private 188 box if they do not want other students to see their comments to a particular student. Subsequent responses and posts between teacher and student are also made private by default when a student/participant marks a post as private with the “Mark as private—visible only to student and teacher” check box. In alternative embodiments, this mark private 188 feature assists with the safe interaction of private conversations between students and teachers, as necessary, or between patients and doctors when patient information might be revealed to third-party assessors of electronic patient record when those third-party assessors are using Grammaticon® technology to assess electronic patient records.

A student/participant in a forum might wish to keep a response private initially but also allow the teacher to make the post visible to all other students in the classroom based on the teacher's judgment and the student's permission once the teacher has reviewed the student's work. In this case, in addition to checking the mark private 188 box, the student checks the grant your teacher discretion 190 box to make the comment visible to all others in class after viewing so that a teacher can make a post visible to all students in the classroom as well as to peer classrooms. A teacher can also force a post to private mode after it is submitted by a student by checking the force private 192 box.

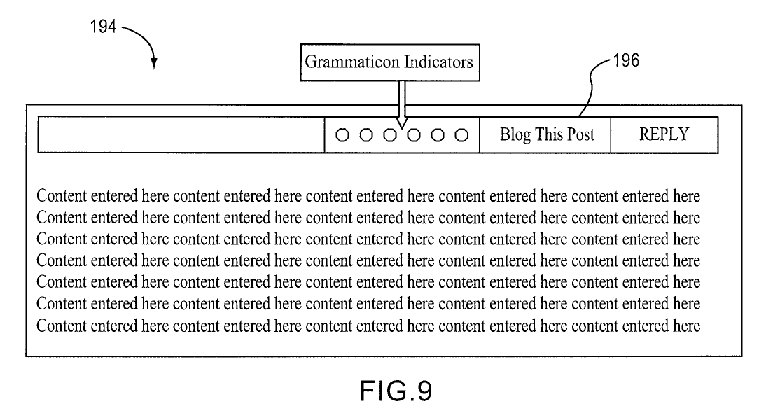

Referring now to FIG. 9, an expand your response element 194 allows students and teachers to post content in response to other student or teacher postings. The expand your response element 194 includes a blog this post 196 feature that allows forum participants (e.g., students, teachers, administrators, etc.) to click a button within the forum they are in and convert their own post into a full weblog (i.e., blog). This allows a participant to expand a topic of interest beyond a threaded discussion and evolve their interest into an internally published blog that the participant can then develop under the supervision of others. The participant is not able to create a blog with the blog this post 196 feature until the teacher has provided permission within the system 100. In addition, once the blog is created, the creator will not be able to restrict teacher access to the blog.

The blog is linked to the original post and maintained behind login/password security to prevent unauthorized viewing by persons and automatic web-bots on the Internet. Security of the expand your response element 194 includes a multi-level approach to blog access. As described above, a student who wishes to create a blog with blog this post 196 feature requires teacher permission within the system prior to being able to create his or her blog. Once the blog is created and the student creates content within the blog, the next level of permission for internal, behind-login publication requires teacher approval prior to publication behind-login. The student then has access control to his or her blog, that is, the creator of the blog has control over selection and publication of comments made to the blog, except for teacher comments made to the blog, which can be posted to the student blog without student permission. Teacher and student creator also have access control permission to force the blog into private mode (once it has been published behind-login) so that only the student who created the blog and the teacher can see it.

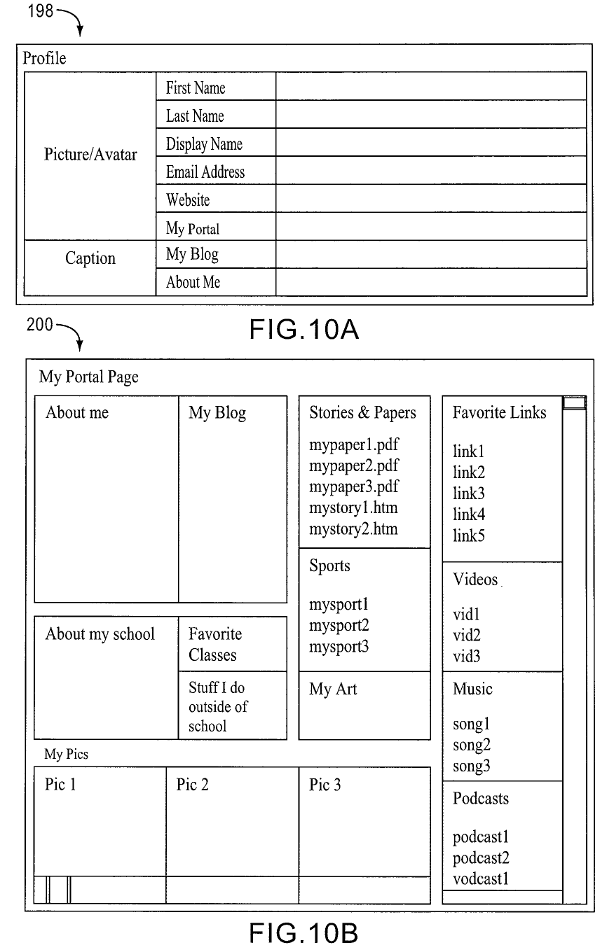

Referring now to FIGS. 10A and 10B, each registered user is provided with a basic profile 198 that includes a variety of fields such as, for example, first name, last name, display name, email address, personal website address, text description, and a picture. This information is viewable and editable by both system administrators (e.g., teachers) and the student whose profile is indicated. Other students can view but not edit the basic student profile.

In addition to the basic profile 198, each user can create his or her own portal 200 (e.g., hosted student website). Within the portal 200, users can add web-based content and expand their profiles beyond the minimal capabilities of the basic profile 198. To create their portal 200, student must be granted sufficient system access, and only the teacher can provide this access to create a portal page. Teachers can also create their own portal pages 200 for publication with or without school administration approval depending on administration policies. When a student creates a portal page 200, the first level of permission allows the student to create the portal page 200 and add content but not publish it. In this phase of development, only the teacher and student creator can edit, view, and comment on the page. After the student has created the portal 200, the teacher can review and approve the content before the portal is published. Once the teacher approves the portal 200 it is viewable by the student, the teacher, and other users of the classroom or other classrooms to which the student is registered.

In order to protect the privacy of students and other users, the basic profiles 198 and portal pages 200 are maintained behind login/password security to prevent unauthorized viewing by persons not registered with the computer system 100. For example, the profiles 198 and portals 200 are not viewable on the Internet. However, the system 100 also includes permission scalability so that a student, with permission of the student's parent(s) and administration of the school or school district, can publish the portal 200 to the Internet. The student has the refined and granular access control to publish his/her portal 200 to the Internet while limiting viewing to a restricted access list per the student's choice. Any subsequent changes to content that is published outside of the behind-login framework can also be restricted such that one or more of the student's parent(s), teacher, and school administrations is required to approve the content changes.

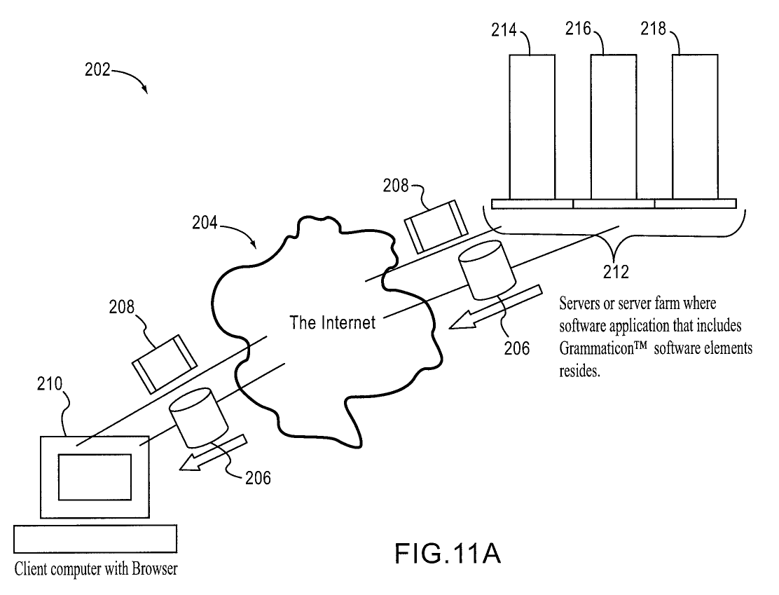

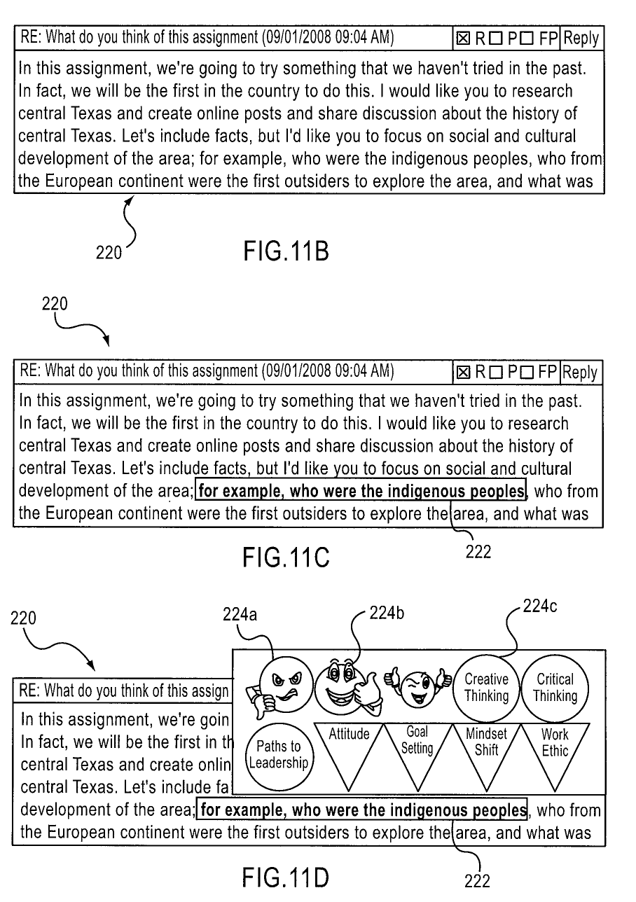

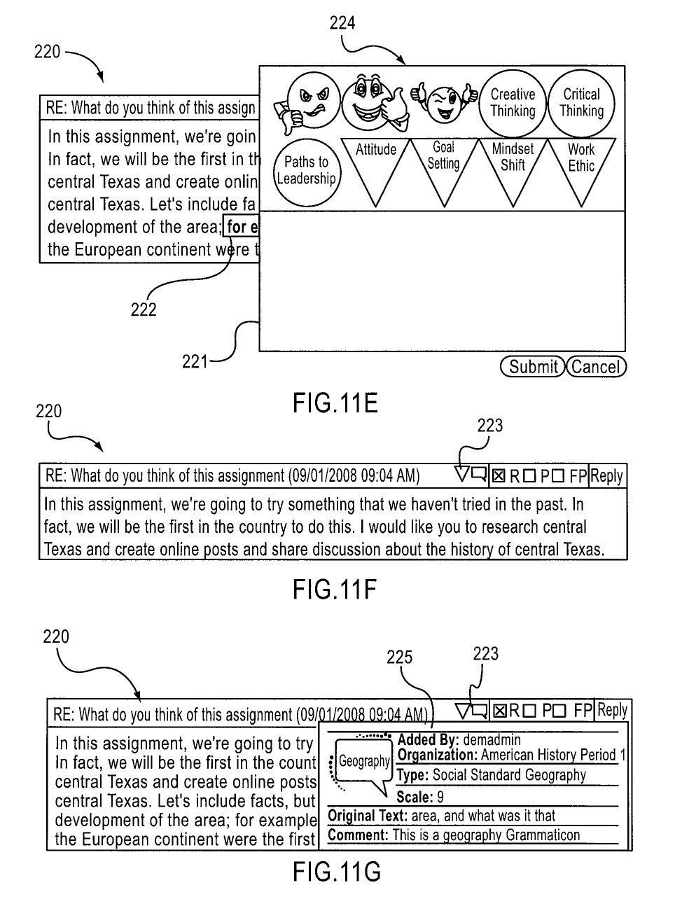

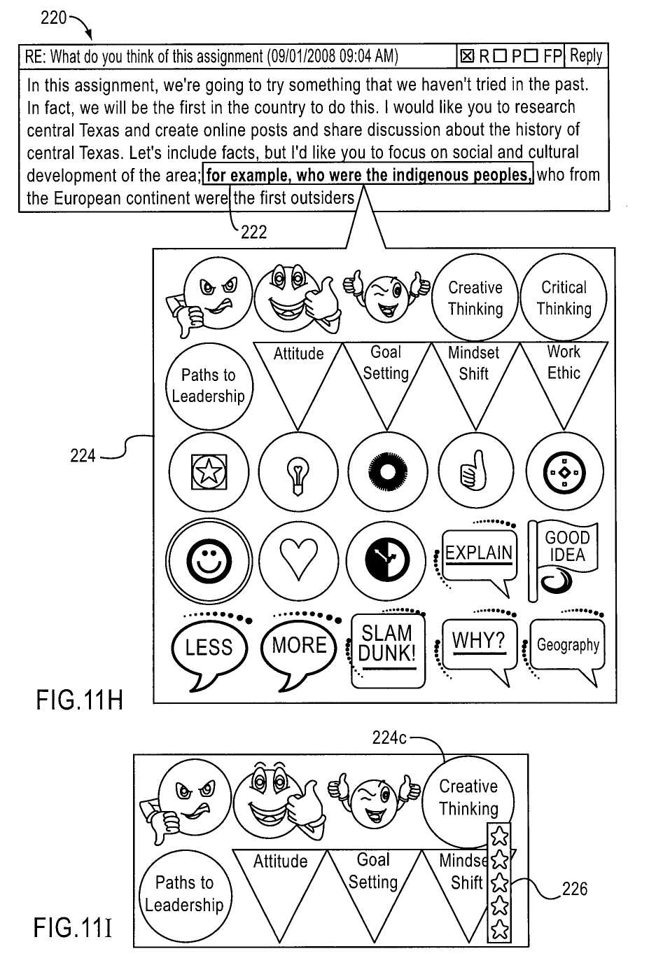

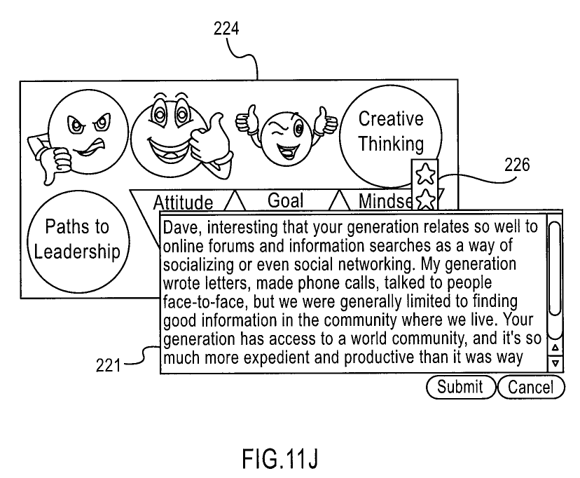

Referring now to FIGS. 11A-11J, the system includes an assessment element 202 with enhanced emoticons, called Grammaticons®, that enable teachers to easily track and report students' progress over time in learning performance and engagement with the subject matter. Grammaticon® technology is a powerful and collaborative knowledge-building-system tool that provides integrated elements for data and information collection, annotation, assessment, aggregation, security, and reporting toward the purpose of extending the value of existing data, and facilitating the creation of new knowledge and collaboratively constructed knowledge. Grammaticon technology is delivered to users by extending the functionality of current generation emoticons and avatars to efficiently annotate, assess, and aggregate web content within formats such as web-based forums, blogs, web-pages, and other web-delivered and web-enabled content.

Grammaticon® technology is delivered across a network based framework 204 through java script program code 206 that detects a local computer's Internet browser and adapts to that browser's capabilities. This feature imparts flexibility to the annotation software and allows users with different Internet browsers to participate in online classrooms and use the annotation software. The software is an overlay that runs resident on a local computer but does not require installation of any additional software programs on the local computer. Grammaticon® technology retains a hierarchical independence from Internet browser code but does detect the browser code so that it can function correctly depending on the specific browser being used on the local computer.

Grammaticon® technology is a client-side program that uses AJAX 208 to communicate between a local computer's Internet browser application 210 and a server or set of servers 212 so that the Grammaticon technology does not have to refresh the entire screen when there is an update to data, and to speed the process of storing the data so that there is less likelihood of information loss. Grammaticon® technology is tied to the data structures behind it. The Grammaticon® software 214 utilizes built-in program code that associates a specific Grammaticon® from the Grammaticon® database 216 to the content of a web page or portion of a web page such as, for example, a highlighted area to be annotated, and then stores that annotation and specific Grammaticon® in a database 218.

The Grammaticon® software is built on a data-driven framework that allows the user to define new Grammaticons instead of simply having to select a Grammaticon® icon from a fixed or pre-programmed set of icons in the database. The user can define a new Grammaticon® icon, define how to support it, add it to a Grammaticon® group, and display the Grammaticon®. The creation of new Grammaticon® icons can be restricted by levels of permission, the specific classroom that a student or teacher is in, or by the organization that the user associated with. In other words, Grammaticon® technology is sensitive to the classroom context a user is in, the security context, and the user's role within the system.

Referring now to FIG. 11B-11G, Grammaticons can be used to annotate and reply to a phrase directly within a forum or blog post 220 without quoting the entire post. For example, as shown in FIG. 11C, the user has selected a phrase to annotate by highlighting the text 222 “for example, who were the indigenous peoples.” This can be done with a mouse, a keyboard, a pen based tool, or touch screen within the web-based media area or web-based text box. After text has been highlighted for annotation and assessment, the user can display the Grammaticon icons 224a, 224b, 224c, etc. (FIG. 11D) by a right-click on the mouse (PC-based computers) or CTRL-click (Mac computers), select a Grammaticon icon 224, and provide qualitative scoring/assessment to the comments and replies. Numerous purpose specific (based upon data-driven rubric) Grammaticon icons 224 are available for selection by the user. As shown in FIG. 11E, after a Grammaticon icon 224 has been selected, the user can leave an annotation-specific message for the specific highlighted text 222 within the post 220 by typing into the Grammaticon message box 221 prior to clicking Submit. After a Grammaticon has been created and submitted, a Grammaticon indicator 223 appears in the title bar of the post 220 (FIG. 11F). When a user hovers over a Grammaticon indicator 223 with the cursor, a message box 225 is displayed showing the details of the Grammaticon (FIG. 11G).

Referring now to FIGS. 11H-11J, the assessment/annotation element 202 (FIG. 11A) can also be used to provide quantitative scoring/assessment by assigning Likert-scale ratings to the Grammaticon® icons 224. For example, as shown in FIG. 11H, the user has selected a phrase to annotate by highlighting the text 222 “for example, who were the indigenous peoples” as described above. After a Grammaticon icon 224 has been selected, e.g., “Creative Thinking” Grammaticon, the user can assign Likert-scale ratings (e.g., one to five stars) to the “Creative Thinking” Grammaticon icon 224c (FIG. 11I). Additionally, as shown in FIG. 11J, the assessment element 202 (FIG. 11A) can also include a message box 221 for the user to add comments to each Grammaticon® 224 that is assigned. Any message that is added to the Grammaticon media dialog box 221 is automatically linked (as part of the data-driven rubric) to the underlying media selected for annotation (e.g., in this case text 222). The Grammaticon® data can then be aggregated, analyzed, and scored based on a data-driven rubric for single posts, multiple posts, aggregated posts, classrooms, multiple classrooms, by teacher, by teaching department, by school, by district, by state, and other dimensional/divisional/geographical and definable parameters to meet reporting needs. With the flexibility of the Grammaticon® structure, users of the system 100 can define multiple rubrics and apply these rubrics based on the needs of the class or organization.

In one embodiment, the Grammaticon® technology can be used by teachers to comment on student work and both qualitatively and quantitatively score and assess student responses/work in a social networking web-based learning environment such as, for example, blogs or forums, so that students, teachers, and other interested parties can track achievement and progress over time in any number of rubric-defined parameters. The Grammaticon® technology can also be used to track continuing education on a teacher-by-teacher basis, over time. For example, individuals or organizations that work with teachers or school systems to assess teacher performance can use Grammaticons to assess and comment on continuing education assignments to improve teaching techniques through continuous professional education (CPE). Additionally, teacher mentors can use Grammaticons to annotate and assess the lessons and assignments that teachers are creating in the online classrooms.

In an alternative embodiment, Grammaticons can be used in electronic office visits and electronic medical records (EMR) as a digital triage mechanism such that a patient's electronic office visit and medical record could be annotated and assessed by qualified medical personnel to assist in the diagnosis of patient needs and illnesses prior to an in-person visit to a doctor's office or treatment facility. In this embodiment, the annotation and assessment of electronic patient records could be performed outside of the physical premises of the doctor's office or treatment center to assist in time savings and economizing of medical expertise within a specific medical setting. In addition, the core content collection software described herein can be used by the patient himself/herself to enter self-descriptive data during an online session to collaboratively conduct an electronic office visit between the healthcare provider and the patient and to build/enhance the patient's electronic medical record prior to a patient visit to a doctor or treatment facility. The core software could be used each time a patient schedules an appointment for a patient visit so that new, self-descriptive, information can be recorded by patient input within the system. As appropriate, and when indicated by embedded artificial intelligence software (AIS), a person scheduling a patient visit could be prompted by the system to answer specific questions in addition to the self-supplied information, based on the information supplied online prior to a visit. This information can be made available to a digital triage center to access, annotate, and assess, prior to the patient visit to the treatment facility.

All of the data associated with the Grammaticon® technology, including icons, rubrics, storage of assessment and annotated data, and the links to source data is stored in a SQL database. Individual Grammaticons are associated with an organization object in the program code. Each Grammaticon® is presented based on the role of the user who will assign a Grammaticon® to a posted blog, forum, or website content. The components of Grammaticons are server-side using AJAX for instant update. In one embodiment, Grammaticons are tied to internally generated/user created web pages. For example, each Grammaticon® is associated with content that is owned and managed by the content creator. In another embodiment, the Grammaticons are linked to non-resident content, for example, the Grammaticons are used to annotate, assess, and aggregate content that is owned and managed by someone other than the person/entity using the Grammaticon to annotate the content. This functionality extends Grammaticon® technology outside of any internally-resident/creator-owned page content. For example, Grammaticon® technology could be readily adapted for use on any web page whose content is created, owned, and hosted by someone other than the creator of the content.

Referring still to FIGS. 11A-11J, in one embodiment, student responses to questions posed by teachers within the assignment are answered in the online classroom within the parameters and framework of a specific assignment. Each student and/or teacher response can receive a plurality of student and/or teacher Grammaticon assessments by students and teachers who are part of the classroom. That is, teachers can create and assign one or multiple teacher-specific Grammaticons for each student response, and students can create and assign one or multiple student-specific Grammaticons for any or all other student and teacher responses in the online assignment. Each of the Grammaticon assessments is stored in a database for subsequent achievement reporting. In another embodiment, students and other members of the online class can assign a Grammaticon assessment icon and comment to the assignment objectives and to any class notes or documents that the teacher has posted. Grammaticons that are posted by students and other members of the online class to provide informative feedback on teacher-supplied class notes and preparatory documents can provide the teacher and other students in the online classroom with constructive feedback on class notes and the other preparatory documents toward better and more complete understanding of assignment objectives and topics that will be studied and discussed within the assignment. In yet another embodiment, the questions that a teacher posts for any assignment can be viewed by another teacher or teacher mentor or someone so assigned as a teaching coach, and the person with the mentor responsibility can assign a plurality of Grammaticons to one or more questions in a teacher's lessons or assignments so as to provide constructive feedback and assessment on question types, techniques, and quality of questions. This aids in the development of teacher practice.

The system also provides teachers and/or classroom content developers with the ability to add lesson plans for use by others users that wish to subscribe to the published content. Lesson plans that are reviewed and approved can be published to the site and made freely available or sold to subscribers for a fee. Subscribers access a lesson, modify it as necessary for their own delivery, and then use the modified template as an online classroom within the functionality defined by the software system described herein.

Individual teachers can also be provided with a variety of self publications tools such as, for example, an online publication framework to publish and get royalties on content that they create rather than go through a big publisher. This publication framework can also include publication-on-approval, allowing a teacher to redefine curricula, publish it for use by others, and then improve the quality of curricula with multiple inputs from others. This set of tools will provide a reduction in curricula development effort and help co-construct consistent and best curricula as well as best practices across one or more schools.

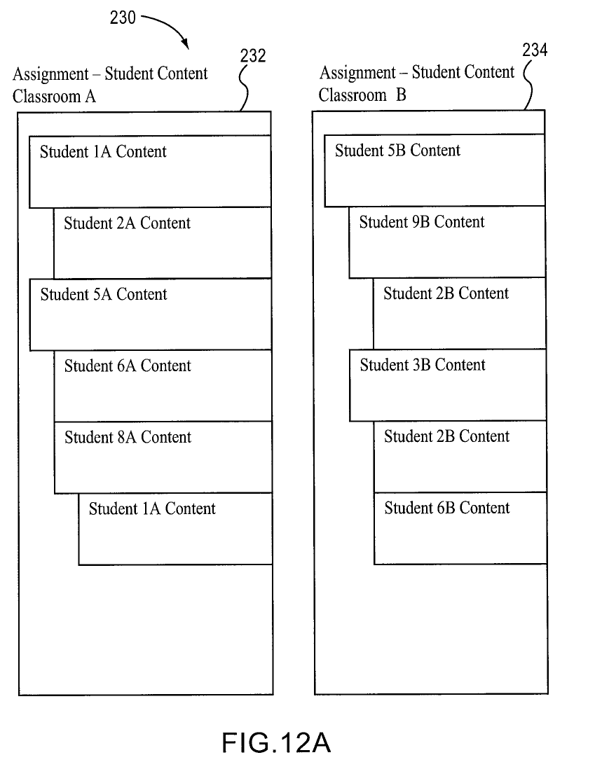

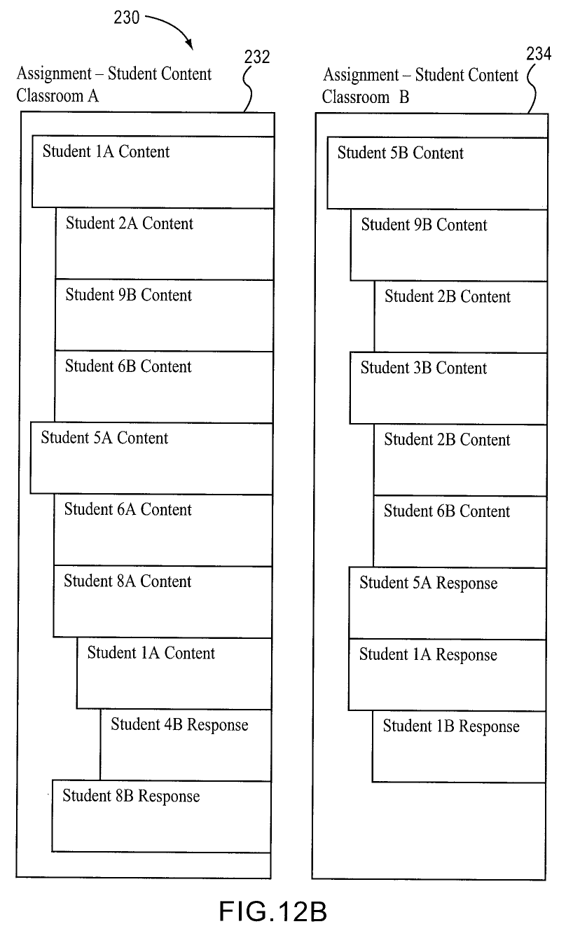

Referring now to FIGS. 12A and 12B, the system 100 includes a publish/subscribe element 230 that provides a method for allowing teachers in one classroom to share student work with peer classrooms. A teacher whose classroom has either completed or is engaged in an online assignment can obtain permission from the students in the classroom to publish the assignment content for viewing by one or more other classrooms. Once the assignments are published by a teacher in one classroom, teachers in one or more other classrooms can view a list of published assignments and then send a subscription request to the originating teacher for a specific classroom assignment. The originating teacher is notified that another teacher wishes to subscribe to their classroom assignment and can then either allow or deny access to their classroom assignment. When permission is allowed by the publishing teacher, a peering arrangement is established between the two classrooms such that the students and teachers in the peer classrooms can engage online with all of the participants of the peering classroom.

FIG. 12A illustrates classroom A 232 and classroom B 234 prior to a peering arrangement being established. FIG. 12B illustrates the two classrooms 232, 234 after the peering arrangement has been established. As shown in FIG. 12B, the students in classroom A 232 can create posts and replies to questions and responses in classroom B 234 and vice versa. The peering arrangement can be terminated once either of the teachers decides to break the peering link between the two classrooms for the specific assignment. At the online classroom assignment level, the publish/subscribe element 230 provides functionality to expand student knowledge outside the bounds of the isolated school and can help to break down social, economic, and geographic barriers. Students can interact regardless of the physical location of their school and with a consistent curriculum or with a differentiated curriculum in other classes.

The system can also include a notification element that provides notification to the user via email, text message, IM message, or online dialog box that there has been activity in his or her account. For example, each time another student responds to a student's post, blog, IM, Grammaticon®, or other online component that is part of the student's record, that student user is notified. The notification element also provides notification to teachers to alert teachers when student responses to assignment questions and assignment assessments have been made within their online classrooms and assignments.

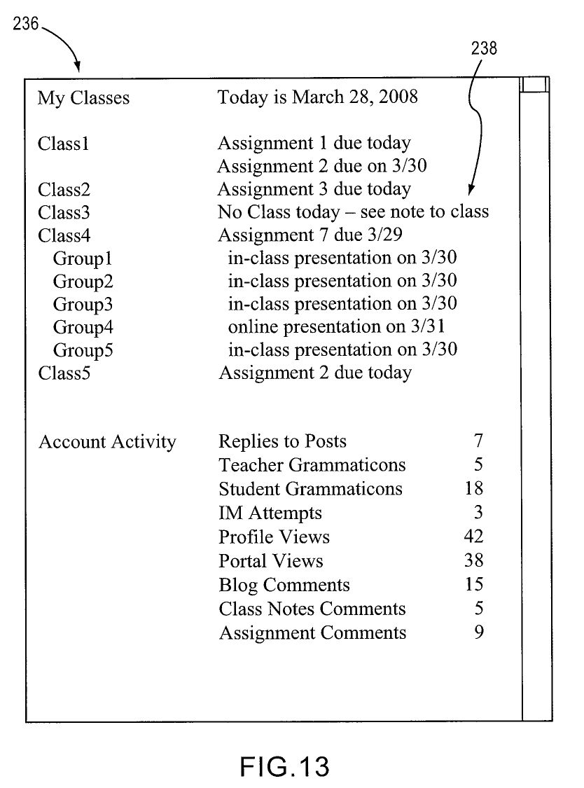

As shown in FIG. 13, the notification element 236 also provides a What's Due reporting feature 238. The What's Due reporting feature 238 delineates and lists assignments that are due along with a “when due” date and time. The What's Due feature 238 for students delineates, for example, student assignments with due dates and times by teacher, by classroom, and by assignment. The What's Due feature 238 for teachers delineates, for example, by school, by classroom, and by student group.

Students and teachers and perhaps other online and registered participants can also be awarded points, according to a proprietary point-award rubric, for their online participation and contributions. For example, when students create a post in response to a teacher-created question, the student will be awarded points that will be tracked in a database and linked to the student's profile. Point totals can be used in student grading, to grant additional permissions so that students can create or post online content, or the points can be used to “purchase” merchandise.

The computer system also includes artificial intelligence software that automatically recognizes similar or related content in the online classrooms (e.g., lessons, assignments, blogs). For example, blogs or discrete components and/or sections of blogs of similar interests and topics from other participants can be linked, so that categorized topic information can be available for review by other participants either with permission by the blog creator, or through the publish/subscribe function as described above.

The artificial intelligence element includes dynamic data-mining elements and table updates that provide for knowledgeable additions to the data-mining search engine so that commonalities across student posts can be retrieved, filtered, and added to the artificial intelligence data-mining search engine to dynamically update the search phrases that will then be looked for across all present and future posts within the classroom front engine. As data elements are identified and tagged within the classroom front engine (where students post their communications, homework, and other relevant or miscellaneous posts) posts that students and teachers have posted, the artificial intelligence data-mining search engine will dynamically filter and link the top 5, 10, or 20 (as specified by users of the system) relevant search results that can be obtained in any of the top search engines such as, for example, Google, Yahoo, YouTube, or Live.com. These search-engine search results are dynamically linked to artificial intelligence identified phrases that a student has used within his or her posts. Also, the artificial intelligence identified phrases that a student has used in posts will be simultaneously connected with the top 5, 10, or 20, etc. results that can be obtained across all registered users within classrooms. This will allow students and teachers to connect with “like” ideas anywhere in the world as dynamically determined by the artificial intelligence data-mining search engine. The artificial intelligence data-mining search engine will also dynamically link students to the top 5, 10, or 20, etc. companies, political agencies, colleges, universities, etc. that have information relevant to students' posts and/or tagged content within students' posts. This will provide a huge time saving mechanism for students and teachers and will also add to their own personal knowledge base. This speeds up the search processes that would otherwise be manually necessary by the student or teacher to locate additional resources that are relevant for the topics being discussed in the classroom.

For example, as a student is typing a response to an assignment question, the artificial intelligence element can identify the term “Grand Canyon” as being related to a preset database of terms or to other items of teaching and/or user content. After the term Grand Canyon has been identify, an indicator appears to alert the user that one or more links have been created. The indicator can include underlining or italicizing the text, changing the font or the color of the font, or providing an indicator icon near the term. When the user hovers over the term with the cursor or clicks on the term, he or she is provided with one or more links to other related and relevant posts and/or websites. The websites may include pictures, video, or descriptions of the Grand Canyon to further enhance the student's learning. The artificial intelligence element can include a predetermined list of keywords or phases. In addition, as content is added to online classrooms, the artificial intelligence element can identify keywords or phases that keep recurring at a relative frequency. After the keywords or phrases are identified, the artificial intelligence element automatically creates the links to related posts and external sources.

The artificial intelligence element also includes sophisticated keyword and content mining software that identifies patterns in user posts, blogs, instant messages, Grammaticons, etc., and prompts the user with additional questions relevant for knowledge building and sharing. The questions can be derived from a pre-set list of questions or can be generated in real time based on prior and contemporaneous input from the user and generated from key words, phrases, and other knowledge contained across a loosely defined database constructed of myriad unique identifiers (UIDs).

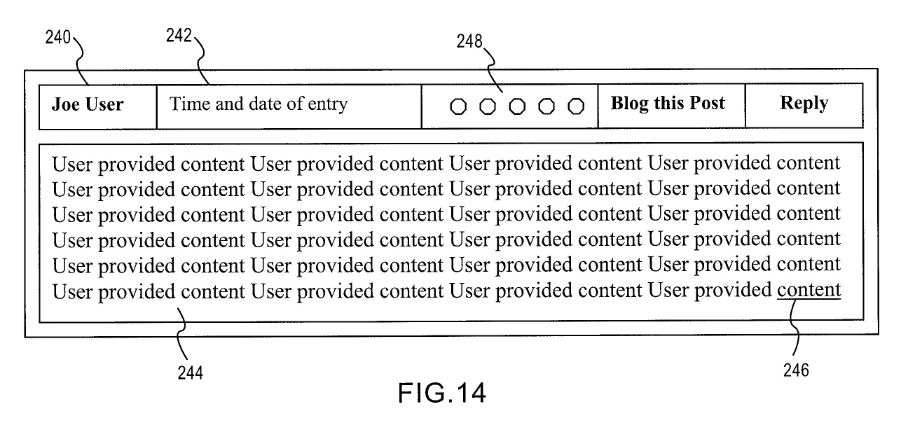

Referring now to FIG. 14, granular UIDs for the participant input and information element is shown. Specific elements within the student forums (classrooms and lessons) and within other online content areas are assigned UIDs that are linked elements of individual student or user UIDs 240. This allows quick searching and identification of user generated content for reporting, displaying, and connecting these specific elements with the creator of the content. UIDs on component elements such as, for example, time and date entries 242, each complete content entry 244, each annotation element 246, or each Grammaticon assigned 248, also provide for a sophisticated level of security creation on content so that content UIDs that are linked to individual user UIDs can be disaggregated from the user UID for generalized reporting and connection to other like information in other databases. In combination with the artificial intelligence software code, these UIDs form a basis for highly secure and privacy-ensured data aggregation across populations of persons and across populations of myriad types of data.

In one embodiment, granular UIDs provide a method of secure data aggregation that secures the identity of the individual from access by others, while at the same time providing rich data reporting potential through aggregation of like UIDs across disparate and divergent populations of data. A built in rubric that prohibits sufficient aggregation of UIDs to identify any individual in a population can also be provided.

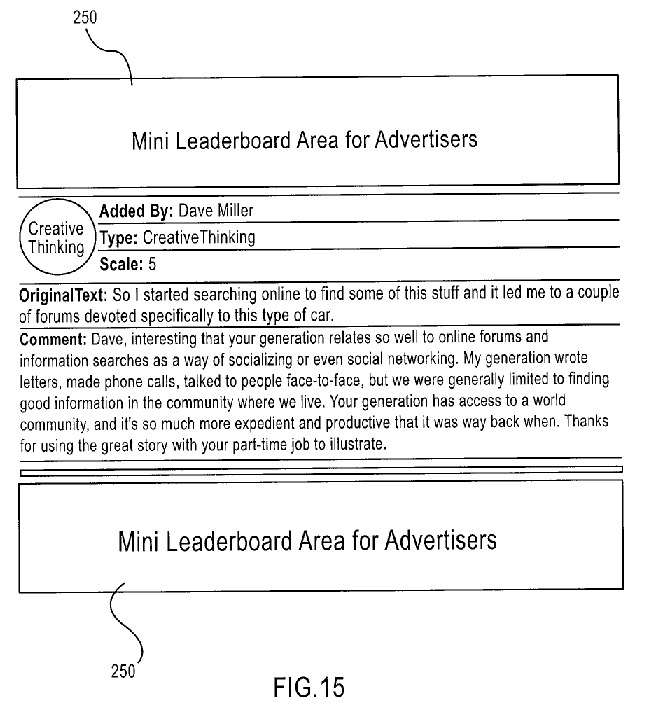

Referring now to FIG. 15, the Grammaticon® technology and Grammaticon® icons provide a unique new way for advertisers to reach an increasingly difficult-to-reach demographic. Each Grammaticon® that is assigned by a teacher or student can be sponsored by one or more advertisers. When a Grammaticon® is selected, the highest bidding advertiser is immediately featured/displayed to the person selecting the Grammaticon®. Once the Grammaticon® is assigned, all sponsors of that Grammaticon® and/or classroom will rotate on a timed basis through a mini-leaderboard 250 which is featured above or below the display of the content posted within the Grammaticon® (user who assigned the Grammaticon®, type of Grammaticon®, original text highlighted, and assignors comment). The mini-leaderboard 250 could also be presented anywhere in the display where the Grammaticon® has been assigned. When a person is viewing Grammaticons that have been assigned to his or her posts within a forum or blog, the mini-leaderboard 250 will be visible for as long as the user is hovering over the Grammaticon® icon that has been attached to a user's post.

Other embodiments incorporating the concepts disclosed herein may be used without departing from the spirit and scope of the invention. For example, the system can include tablet or touch screen technology that allows students to take notes or respond to assignment questions directly in electronic form. This feature can be particularly useful in certain subject areas such as, for example, math and science, where traditional typewritten words may by inadequate. The tablet technology allows a student to write out equations or draw diagrams that can then be commented on with all of the features described above (e.g., Grammaticons, etc.).

What is claimed is:

1. A computer-readable medium storing computer-executable program instructions that, when executed, cause one or more computers to:
enable a user in a community of users to generate one or more items of user content, each item of user content being associated with one or more items of teaching content or another item of user content;
enable the user to generate an annotation associated with at least one item of teaching content or at least one item of user content; and
display the annotation overlaid on the associated item of teacher or user content.

2. The computer-readable medium according to claim 1, wherein the computer-executable program instructions, when executed, also cause the one or more computers to identify patterns in the items of teaching content and the items of user content indicative of similar topics.

3. The computer-readable medium according to claim 2, wherein the computer-executable program instructions, when executed, also cause the one or more computers to provide a link to the items of teaching content and items of user content identified as being similar, topics.

4. The computer-readable medium according to claim 2, wherein the computer-executable program instructions, when executed, also cause the one or more computers to provide a link to an external source linked over a communications network.

5. The computer-readable medium according to claim 4 wherein the external source is the World Wide Web.

6. An apparatus for providing a collaborative learning environment accessible by a community of users over a communications network, comprising:
a memory storing a program;
a processor in communication with the memory, the processor for executing the program and thereby causing the apparatus to:
enable a user in a community of users to generate one or more items of user content, each item of user content being associated with one or more items of teaching content or another item of user content;
enable the user to generate an annotation associated with at least one item of teaching content or at least one item of user content; and
display the annotation overlaid on the associated item of teacher or user content.

7. The apparatus according to claim 6, wherein the program, when executed, also causes the apparatus to identify patterns in the items of teaching content and the items of user content indicative of similar topics.

8. The apparatus according to claim 7, wherein the program, when executed, also causes the apparatus to provide a link to the items of teaching content and items of user content identified as being similar topics.

9. The apparatus according to claim 7, wherein the program, when executed, also causes the apparatus to provide a link to an external source linked over a communications network.

10. The apparatus according to claim 9 wherein the external source is the World Wide Web.

11. A system for providing a collaborative learning environment accessible by a community of users over a communications network, comprising:
means for storing data comprising one or more items of teaching content and one or more items of user content, the items of teaching content include content previously stored in the data storing means, and the items of user content include content generated by the community of users;
means for generating one or more items of user content, each item of user content being associated with one or more items of teaching content or another item of user content;
means for generating an annotation associated with at least one item of teaching content or at least one item of user content; and
means for displaying the annotation overlaid on the associated item of teacher or user content.

12. The system according to claim 11, further comprising means for identifying patterns in the items of teaching content and the items of user content indicative of similar topics.

13. The system according to claim 12, further comprising means for providing a link to items of teaching content or items of user content identified as being similar topics.

14. The system according to claim 12, further comprising means for providing a link to an external source linked over a communications network.

15. The system according to claim 11, further comprising means for managing content configured to provide users with personalized disk space in the data storing means.

16. The system according to claim 15 wherein the means for managing content includes a media library for storing online media files.

17. The system according to claim 11 wherein the one or more items of teaching content includes embedded HyperText Markup Language (HTML).

18. The system according to claim 11 wherein the community of users includes a plurality of online classrooms linked over a communication network.

19. The system according to claim 18 wherein each of the plurality of online classrooms include one or more teachers and one or more students, the plurality of online classrooms linked over a communications network allows students and teachers in one online classroom to share items of teaching content and items of user content with students and teachers in other online classrooms.

20. A method of providing a collaborative learning environment to an online community of users, the method comprising:
providing a data storage device for storing data comprising a plurality of items of teaching content;
generating one or more items of user content associated with the items of teaching content or another item of user content;
generating an annotation associated with at least one item of teaching content or at least one item of user content; and
displaying the annotation overlaid on the associated item of teacher or user content.

21. The method according to claim 20 further comprising:
identifying patterns in the items of teaching content and the items of user content indicative of similar topics.

22. The method according to claim 21 further comprising:
providing a link to the items of teaching content and items of user content identified as being similar topics.

23. The method according to claim 21 further comprising:
providing a universal resource locator link to a website.

24. A computerized collaborative learning system comprising:
a data storage device for storing data comprising items of teaching content and items of user content, the items of teaching content include content previously stored in the data storage device, and the items of user content include content generated by the community of users;
a set of collaborative system tools operable to provide a user in the community of users the ability to generate an item of user content, each item of user content being associated with items of teaching content or other items of user content; and
an annotation mechanism operable to enable users in the community of users to generate an annotation associated with items of teaching content or items of user content for storage in the data storage device, the annotation mechanism configured to merge the annotation with the associated item of teacher or user content and generate merged content with the annotation overlaid on the associated item of teacher or user content.

25. The computerized collaborative learning system according to claim 24, further comprising a display device for displaying the merged content with the annotation overlaid on the associated item of teacher or user content.

26. The computerized collaborative learning system according to claim 24, further comprising a pattern identification mechanism operable to identify patterns in items of teaching content and items of user content indicative of similar topics.
